(19) United States
(12) Patent Application Publication
(10) Pub. No.: US 2023/0077963 A1
(43) Pub. Date: Mar. 16, 2023

(54) NOTIFY AMF/MME WITH UE RADIO CAPABILITY ID WITH VERSION ID INCREMENT

(71) Applicant: Telefonaktiebolaget LM Ericsson (publ), Stockholm (SE)

(72) Inventor: Yong Yang, Kållered (SE)

(21) Appl. No.: 17/801,058

(22) PCT Filed: Feb. 19, 2021
(86) PCT No.: PCT/EP2021/054185

§ 371 Date: Aug. 19, 2022

Related U.S. Application Data
(60) Provisional application No. 62/979,130, filed on Feb. 20, 2020.

(51) Int. Cl. H04W 8/24; H04W 68/00

(52) U.S. Cl. CPC H04W 8/24; H04W 68/005; H04W 84/042

(57) ABSTRACT

Disclosed herein is a method of operation a core network entity (e.g., an AMF or MME) in a core network of a cellular communications system. The method comprises: receiving, from another core network entity (e.g., UMCF), a notification message that comprises a request to replace a PLMN UE radio capability ID(s) containing a first version ID with a PLMN UE radio capability ID(s) containing a second version ID, the second version ID being newer than the first version ID; and performing one or more actions responsive to receiving the notification message.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

The 3^{rd} Generation Partnership Project (3GPP) Technical Specifications Group (TSG) Service and System Aspects (SA) Working Group 2 (i.e., “SA2”) has introduced a field referred to as “Version ID” in the Public Land Mobile Network (PLMN) Assigned User Equipment (UE) Radio Capability ID. However, SA2 has not clearly defined how this field should be used.

Clause 5.4.4.1a of TS 23.501 states:
UEs, AMFs and RAN nodes which support RACS learn the current value of the Version ID when a new PLMN assigned UE Radio Capability ID is received from the UCMF and the Version ID it contains is different from the ones in their PLMN Assigned UE Radio Capability ID cache. PLMN assigned UE Radio Capability IDs related to old values of the Version ID can be removed from cache with priority.

Clause 5.9.10 of TS 23.501 states:
The PLMN assigned UE Radio Capability ID includes a Version ID in its format. The value of the Version ID is the one configured in the UCMF, at time the UE Radio Capability ID value is assigned. The Version ID value makes it possible to detect whether a UE Radio Capability ID is current or outdated.

Clause 6.2.21 of TS 23.501 states:
The UCMF stores a Version ID value for the PLMN assigned UE Radio Capability IDs so it is included in the PLMN assigned UE Radio Capability IDs it assigns. This shall be configured in the UCMF.

Nokia has submitted a CR that tries to make use of Version ID, but they failed to explain how it should work. See contribution from Nokia attached hereto as Appendix I. It seems other companies are quite positive to the mechanism using the Version ID in the PLMN Assigned UE Radio Capability ID.

Appendix I contains the intended use of Version ID, but it does not work.

The CR attached hereto as Appendix II contains the definition of Version ID and UE Radio Capability ID.

### SUMMARY

There currently exist certain challenge(s). The key issues here are: (1) how the UE radio Capability Management Function (UCMF) can notify the Access and Mobility Management Function (AMF) or Mobility Management Entity (MME) (denoted herein as “AMF/MME”) that a new version of UE Radio Capability is created and (2) how the AMF/MME can update the UE with new version of UE Radio Capability ID, to replace the staled UE Radio Capability ID stored in the UE.

As of today, the UCMF can only use Notification Request to send a request to the AMF/MME to DELETE PLMN assigned UE Radio Capability ID, and then the AMF/MME sends a request to the UE to switch to use Manufacturer Assigned UE Radio Capability ID. See below copied from TS 23.501, 5.4.4.1a.

When a PLMN decides to switch to request a particular type of UE to use manufacturer-
assigned UE Radio Capability ID(s):
The UCMF sends a Nucmf_UECapabilityManagement_Notify message to the AMF
including either a list of UE Radio Capability IDs (if the UE was previously using any
PLMN assigned IDs) or the TAC values corresponding to UE types that are requested to
use manufacturer-assigned UE Radio Capability ID. These values are stored in a
“Manufacturer Assigned operation requested list” in the AMF.
The AMF uses the Registration Accept message or the UE Configuration Update
command message to request the UE to delete all the PLMN-assigned UE Radio
Capability ID(s) for this PLMN if the UE is, respectively, registering or is registered with
PLMN assigned ID or TAC values matching one value in the Manufacturer Assigned
operation requested list.
NOTE 1: It is expected that in a given PLMN the UCMF and AMFs will be configured to
either use a Manufacturer Assigned operation requested list based on a list of
PLMN assigned UE Radio Capability IDs or a list of TACs, but not both.
NOTE 2: The strategy for triggering of the deletion of PLMN-assigned UE Radio Capability
ID(s) in the UE by the AMF is implementation-specific (e.g. can be used only
towards UEs in CM_Connected state).
a UE that receives indication to delete all the PLMN-assigned UE Radio Capability IDs in
the Registration Accept message, or UE Configuration Update command message, shall
delete any PLMN-assigned UE Radio Capability IDs for this PLMN. The UE proceeds to
register with a Manufacturer assigned UE Radio Capability ID that is applicable to the
current UE Radio configuration.
When the “Manufacturer Assigned operation requested list” contains PLMN assigned UE
Radio Capability IDs, the UCMF shall avoid re-assigning PLMN assigned UE Radio
Capability IDs that were added to the ″Manufacturer Assigned operation requested list″
in the AMFs to any UE.
The AMF stores a PLMN assigned ID in the Manufacturer Assigned operation requested
list for a time duration that is implementation specific, but TACs are stored until the
UCMF require to remove certain TACs from the list (i.e. the list of TACs which are
requested to use Manufacturer Assigned IDs in the AMF and UCMF is synchronised at
all times).
The UCMF can request at any time the AMF to remove PLMN assigned ID(s) or TAC(s)
values form the Manufacturer Assigned operation requested list.
NOTE 3: The AMF can decide to remove a UE Radio Capability ID from the “Manufacturer
Assigned operation requested list” list e.g. because no UE with that UE Radio
Capability ID has connected to the network for long time. If later a UE with such
UE Radio Capability ID connects to the network, the AMF contacts the UCMF to
resolve the UE Radio Capability ID, and at this point the UCMF can trigger again
the deletion of the UE Radio Capability ID by including this in the Manufacturer
Assigned operation requested list of the AMF.
The serving AMF stores the UE Radio Capability ID for a UE in the UE context and provides
this UE Radio Capability ID to NG-RAN as part of the UE context information using N2
signalling. During inter PLMN mobility, the new AMF shall delete the UE Radio Capability ID
received from the old AMF, unless the operator policy indicates that all UE Radio Capability
IDs used in the old PLMN is also valid in the new PLMN.
The UE stores the PLMN-assigned UE Radio Capability ID in non-volatile memory when in
RM-DEREGISTERED state and can use it again when it registers in the same PLMN.

Certain aspects of the present disclosure and their embodiments may provide solutions to the aforementioned or other challenges. Embodiments disclosed herein introduce a mechanism to enable a UCMF to notify the AMF/MME to replace one or more PLMN Assigned UE Radio Capability IDs containing a lower version (i.e. staled/deprecated UE Radio Capability ID) with one or more PLMN Assigned UE Radio Capability IDs containing a newer version correspondingly.

In one embodiment, the mechanism includes:
1. If the UCMF has not restarted and has a valid subscription (from the AMF/MME) to send the notification to the AMF/MME:
   a. The UCMF sends a notification request message to the AMF/MME, in the UcmfNotificationData. It includes an operation to request the AMF/MME to REPLACE one or more PLMN Assigned UE Radio Capability IDs containing a lower version (i.e. staled/deprecated UE Radio Capability ID) with one or more PLMN Assigned UE Radio Capability IDs containing a newer version correspondingly.
2. If the UCMF has restarted and it should indicate to AMF/MME it has restarted e.g. via Recovery Time Stamp, the AMF/MME which has contacted to UCMF before its restart subscribes (e.g., immediately) to the UCMF to receive Notification Request. After the AMF/MME subscribes to get UCMF's notifications, the UCMF sends a notification request message to the AMF/MME, in the UcmfNotificationData. It includes an operation to request the AMF/MME to REPLACE one or more PLMN Assigned UE Radio Capability IDs containing a lower version (i.e. staled/deprecated UE Radio Capability ID) with one or more PLMN Assigned UE Radio Capability IDs containing a newer version correspondingly.
3. Once the AMF/MME receives such a request (operation) to REPLACE the PLMN Assigned UE Radio Capability ID, the AMF/MME acts accordingly. For instance, the AMF/MME requests the respective UE to replaces the one or more PLMN Assigned UE Radio Capability IDs containing a lower version (i.e. staled/deprecated UE Radio Capability ID) with one or more PLMN Assigned UE Radio Capability IDs containing a newer version correspondingly.

Certain embodiments may provide one or more of the following technical advantage(s). The proposed solution enables to make use of Version ID, and efficiently to update AMF/MME and UE to replace a staled PLMN assigned UE Radio Capability.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a reproduction of FIG. 4.2.5a-1 from TS 23.501;

FIG. 2 is a reproduction of FIG. 4.2.5-1 from TS 23.401;

FIG. 3 illustrates one example of a cellular communications system 300 in which embodiments of the present disclosure may be implemented;

FIG. 4 illustrates a procedure in accordance with one example embodiment of the present disclosure;

FIG. 5 is a schematic block diagram of a network node 500 according to some embodiments of the present disclosure;

FIG. 6 is a schematic block diagram that illustrates a virtualized embodiment of the network node 500 according to some embodiments of the present disclosure;

FIG. 7 is a schematic block diagram of the network node 500 according to some other embodiments of the present disclosure;

FIG. 8 is a schematic block diagram of a wireless communication device 800 according to some embodiments of the present disclosure;

FIG. 9 a schematic block diagram of the wireless communication device 800 according to some other embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Additional information may also be found in the document(s) provided in the Appendices.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Function (AMF), a UPF, a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Systems and methods are disclosed herein for notifying AMF or MME with UE Radio Capability ID with version ID increment.

Systems and methods are disclosed herein for replacing staled PLMN Assigned UE Radio Capability with out-of-dated version ID with a new UE Radio Capability ID (with new version).

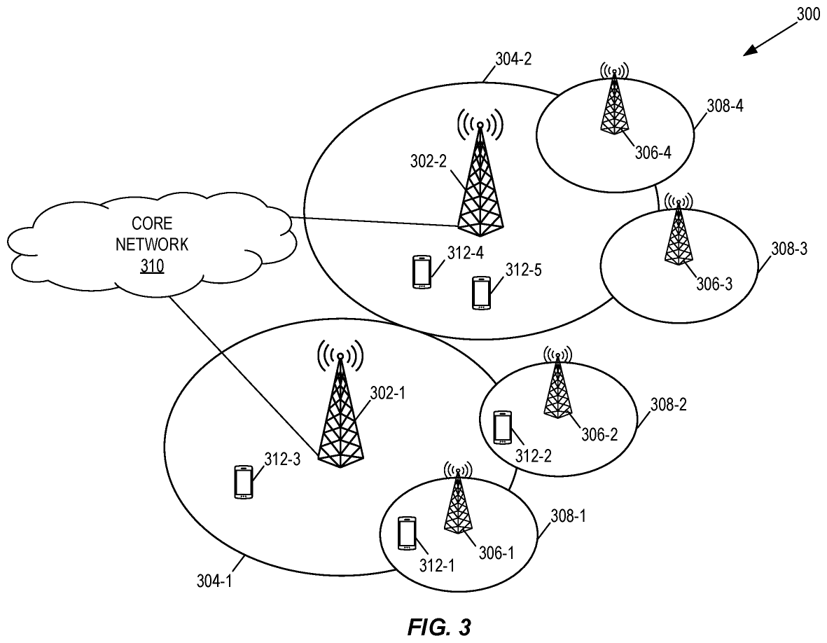

### FIG. 3

FIG. 3 illustrates one example of a cellular communications system 300 in which embodiments of the present disclosure may be implemented. In the embodiments described herein, the cellular communications system 300 is a 5G system (5GS) including a NR RAN or NG-RAN and a 5G Core (5GC) or a Evolved Packet System (EPS) including an LTE RAN (i.e., an E-UTRAN) and a Evolved Packet Core (EPC). In this example, the RAN includes base stations 302-1 and 302-2, which in the 5GS are referred to as gNBs (i.e., NR RAN nodes) or ng-NBs (i.e., LTE RAN nodes connected to 5GC) and in the EPS are referred to as eNBs, controlling corresponding (macro) cells 304-1 and 304-2. The base stations 302-1 and 302-2 are generally referred to herein collectively as base stations 302 and individually as base station 302. Likewise, the (macro) cells 304-1 and 304-2 are generally referred to herein collectively as (macro) cells 304 and individually as (macro) cell 304. The RAN may also include a number of low power nodes 306-1 through 306-4 controlling corresponding small cells 308-1 through 308-4. The low power nodes 306-1 through 306-4 can be small base stations (such as pico or femto base stations) or Remote Radio Heads (RRHs), or the like. Notably, while not illustrated, one or more of the small cells 308-1 through 308-4 may alternatively be provided by the base stations 302. The low power nodes 306-1 through 306-4 are generally referred to herein collectively as low power nodes 306 and individually as low power node 306. Likewise, the small cells 308-1 through 308-4 are generally referred to herein collectively as small cells 308 and individually as small cell 308. The cellular communications system 300 also includes a core network 310, which in the 5GS is referred to as the 5G core (5GC) and in the EPS is referred to as the EPC. The base stations 302 (and optionally the low power nodes 306) are connected to the core network 310.

The base stations 302 and the low power nodes 306 provide service to wireless communication devices 312-1 through 312-5 in the corresponding cells 304 and 308. The wireless communication devices 312-1 through 312-5 are generally referred to herein collectively as wireless communication devices 312 and individually as wireless communication device 312. In the following description, the wireless communication devices 312 are oftentimes UEs, but the present disclosure is not limited thereto.

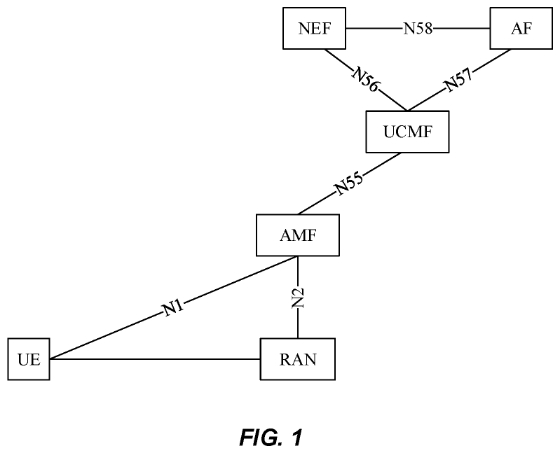

### FIG. 1

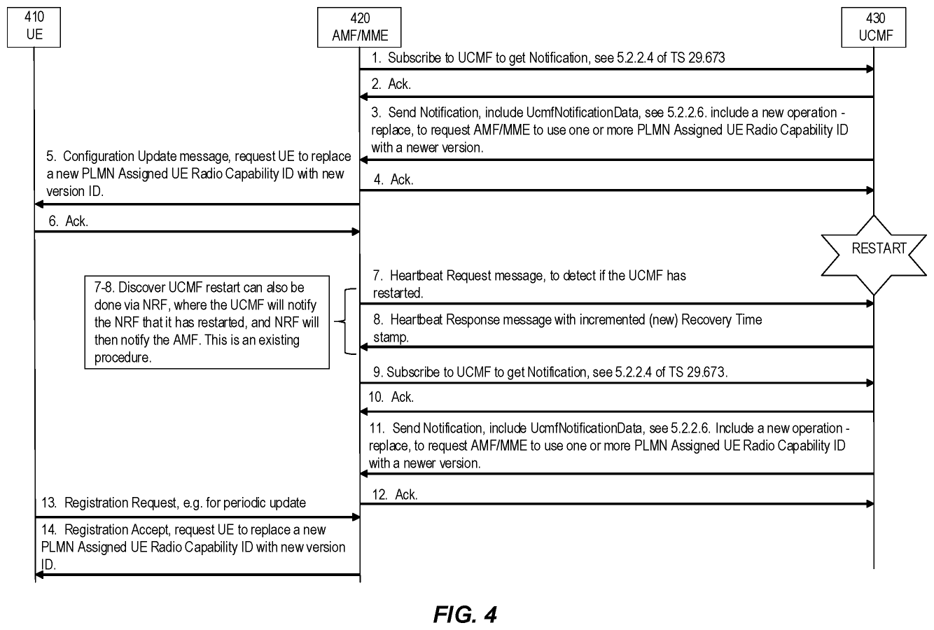

FIG. 1 is a reproduction of FIG. 4.2.5a-1 from TS 23.501, which illustrates the Radio Capability Signaling optimization architecture in the 5GS.

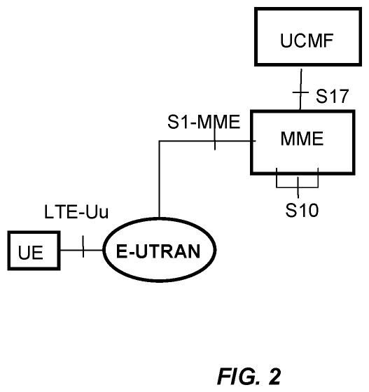

### FIG. 2

FIG. 2 is a reproduction of FIG. 4.2.5-1 from TS 23.401, which illustrates the Radio Capability Signaling optimization architecture in the EPS.

FIG. 4.2.5-1 of TS23.501 (FIG. 2) depicts the EPS architecture supporting RACS. RACS is further described in clause 5.11.3a of TS 23.401. The EPS architecture supporting provisioning of UCMF is described in TS 23.682.

### FIG. 4

FIG. 4 illustrates a procedure in accordance with one example embodiment of the present disclosure. Note that not all steps shown in FIG. 4 are required. For example, steps 1-6 may be performed without the remaining steps. Likewise, steps 7-14 may be performed without steps 1-6. Other examples are also possible.

The steps of the procedure of FIG. 4 are as follows:
Step 1: The AMF/MME subscribes to UCMF to get notification(s), preferably notification(s) about UE Radio Capability for an UE served by the AMF/MME, e.g. about an update of a UE Radio Capability ID for the UE, e.g. an update of a PLMN Assigned UE Radio Capability ID for the UE.
Step 2: The UCMF replies with an ACK.
Step 3: The UCMP sends a notification to the AMF/MME in response to said subscription to get notification(s). The notification includes UcmfNotificationData, preferably as in TS 29.673 clause 5.2.2.6. However, in accordance with an embodiment of the present disclosure, the notification and/or the UcmfNotificationData includes a new operation “replace” to request the AMF/MME to use one or more PLMN Assigned UE Radio Capability IDs with a newer version.
Step 4: The AMF/MME responds with an ACK.
Step 5: The AMF/MME sends a Configuration Update message to the UE that requests the UE to replace a PLMN Assigned UE Radio Capability ID with a new version ID.
Step 6: The UE responds with an ACK.
Steps 7-8: At some point, the UCMF restarts and the AMF/MME detects or otherwise discovers that the UCMF has restarted. In this example, this is done by the AMF/MME sending a Heartbeat Request message to the UCMF and receiving Heartbeat Response message with incremented (new) Recovery Time Stamp or similar. Alternatively, the AMF/MME may discover the restart via a NRF, where the UCMF notifies the NRF that it has restarted, and the NRF will then notify the AMF/MME.
Step 9: The AMF/MME subscribes to UCMF to get notification(s). For example, as in step 1 above.
Step 10: The UCMF replies with an ACK.
Step 11: The UCMP sends a notification to the AMF/MME in response to said subscription to get notification(s). The notification includes UcmfNotificationData, preferably as in TS 29.673 clause 5.2.2.6. However, in accordance with an embodiment of the present disclosure, the notification and/or the UcmfNotificationData includes a new operation “replace” to request the AMF/MME to use one or more PLMN Assigned UE Radio Capability IDs with a newer version.
Step 12: The AMF/MME responds with an ACK.
Step 13: The UE sends a Registration Request to the AMF/MME, e.g., for periodic update.
Step 14: The AMF/MME responds to the UE with a Registration Accept message that requests the UE to replace a PLMN Assigned UE Radio Capability ID with a new version ID.

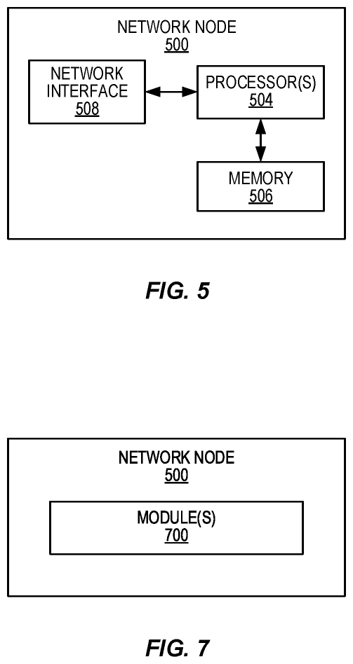

### FIG. 5

FIG. 5 is a schematic block diagram of a network node 500 according to some embodiments of the present disclosure. Optional features are represented by dashed boxes. The network node 500 may be, for example, a network node that implements all or part of the functionality of a UMCF, a MME, or an AMF according to any of the embodiments described herein. As illustrated, the network node 500 includes one or more processors 504 (e.g., Central Processing Units (CPUs), Application Specific Integrated Circuits (ASICs), Field Programmable Gate Arrays (FPGAs), and/or the like), memory 506, and a network interface 508. The one or more processors 504 are also referred to herein as processing circuitry. The one or more processors 504 operate to provide one or more functions of the network node 500 as described herein (e.g., all or part of the functionality of a UMCF, a MME, or an AMF according to any of the embodiments described herein). In some embodiments, the function(s) are implemented in software that is stored, e.g., in the memory 506 and executed by the one or more processors 504.

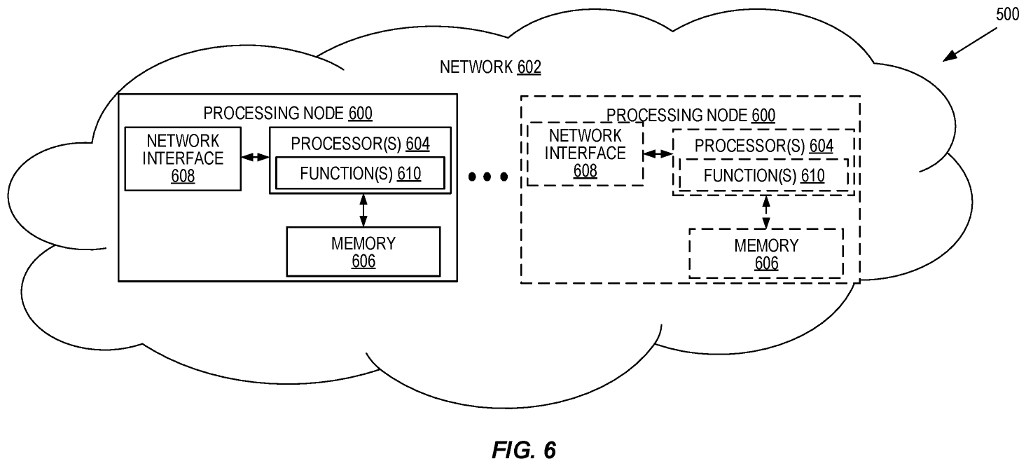

### FIG. 6

FIG. 6 is a schematic block diagram that illustrates a virtualized embodiment of the network node 500 according to some embodiments of the present disclosure. Again, optional features are represented by dashed boxes.

As used herein, a “virtualized” network node is an implementation of the network node 500 in which at least a portion of the functionality of the network node 500 (e.g., all or part of the functionality of a UMCF, a MME, or an AMF according to any of the embodiments described herein) is implemented as a virtual component(s) (e.g., via a virtual machine(s) executing on a physical processing node(s) in a network(s)). As illustrated, in this example, the network node 500 includes one or more processing nodes 600 coupled to or included as part of a network(s) 602. Each processing node 600 includes one or more processors 604 (e.g., CPUs, ASICs, FPGAs, and/or the like), memory 606, and a network interface 608.

In this example, functions 610 of the network node 500 described herein (e.g., all or part of the functionality of a UMCF, a MME, or an AMF according to any of the embodiments described herein) are implemented at the one or more processing nodes 600 or distributed across the two or more processing nodes 600 in any desired manner. In some particular embodiments, some or all of the functions 610 of the network node 500 described herein are implemented as virtual components executed by one or more virtual machines implemented in a virtual environment(s) hosted by the processing node(s) 600.

In some embodiments, a computer program including instructions which, when executed by at least one processor, causes the at least one processor to carry out the functionality of the network node 500 or a node (e.g., a processing node 600) implementing one or more of the functions 610 of the radio access node 500 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

### FIG. 7

FIG. 7 is a schematic block diagram of the network node 500 according to some other embodiments of the present disclosure. The network node 500 includes one or more modules 700, each of which is implemented in software. The module(s) 700 provide the functionality of the network node 500 described herein (e.g., all or part of the functionality of a UMCF, a MME, or an AMF according to any of the embodiments described herein). This discussion is equally applicable to the processing node 600 of FIG. 6 where the modules 700 may be implemented at one of the processing nodes 600 or distributed across multiple processing nodes 600.

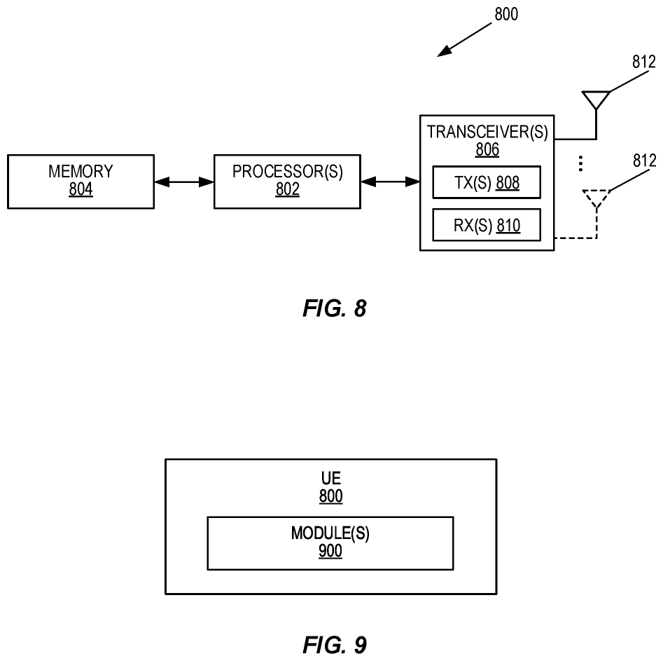

### FIG. 8

FIG. 8 is a schematic block diagram of a wireless communication device 800 according to some embodiments of the present disclosure. As illustrated, the wireless communication device 800 includes one or more processors 802 (e.g., CPUs, ASICs, FPGAs, and/or the like), memory 804, and one or more transceivers 806 each including one or more transmitters 808 and one or more receivers 810 coupled to one or more antennas 812. The transceiver(s) 806 includes radio-front end circuitry connected to the antenna(s) 812 that is configured to condition signals communicated between the antenna(s) 812 and the processor(s) 802, as will be appreciated by on of ordinary skill in the art. The processors 802 are also referred to herein as processing circuitry. The transceivers 806 are also referred to herein as radio circuitry. In some embodiments, the functionality of the wireless communication device 800 described above (e.g., functionality of a UE) may be fully or partially implemented in software that is, e.g., stored in the memory 804 and executed by the processor(s) 802. Note that the wireless communication device 800 may include additional components not illustrated in FIG. 8 such as, e.g., one or more user interface components (e.g., an input/output interface including a display, buttons, a touch screen, a microphone, a speaker(s), and/or the like and/or any other components for allowing input of information into the wireless communication device 800 and/or allowing output of information from the wireless communication device 800), a power supply (e.g., a battery and associated power circuitry), etc.

In some embodiments, a computer program including instructions which, when executed by at least one processor, causes the at least one processor to carry out the functionality of the wireless communication device 800 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

### FIG. 9

FIG. 9 is a schematic block diagram of the wireless communication device 800 according to some other embodiments of the present disclosure. The wireless communication device 800 includes one or more modules 900, each of which is implemented in software. The module(s) 900 provide the functionality of the wireless communication device 800 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### EMBODIMENTS

Some of the embodiments described above can be summarized in the following manner:

1. A method of operation a core network entity (e.g., an AMF or MME) in a core network of a cellular communications system, the method comprising:
receiving (FIG. 4, step 3; FIG. 4, step 11), from another core network entity (e.g., UMCF), a notification message that comprises a request to replace a PLMN UE radio capability ID(s) containing a first version ID with a PLMN UE radio capability ID(s) containing a second version ID, the second version ID being newer than the first version ID; and
performing (FIG. 4, step 5; FIG. 4, step 14) one or more actions responsive to receiving the notification message.

2. The method of embodiment 1 wherein performing (FIG. 4, step 5; FIG. 4, step 14) the one or more actions comprises sending (FIG. 4, step 5; FIG. 4, step 14), to a UE, a request to replace the PLMN UE radio capability ID(s) containing the first version ID with the PLMN UE radio capability ID(s) containing the second version ID.

3. The method of embodiment 1 or 2 wherein the other network entity is a UMCF.

4. The method of embodiment 3 further comprising:
subscribing (FIG. 4, step 1) to the UMCF to get notifications;
wherein receiving (FIG. 4, step 3; FIG. 4, step 11) the notification message comprises receiving (FIG. 4, step 3) the notification message responsive to subscribing (FIG. 4, step 1) to the UMCF to get notifications.

5. The method of embodiment 3 further comprising:
discovering (FIG. 4, steps 7-8) that the UMCF has restarted; and
responsive to discovering (FIG. 4, steps 7-8) that the UMCF has restarted, subscribing (FIG. 4, step 9) to the UMCF to get notifications;
wherein receiving (FIG. 4, step 3; FIG. 4, step 11) the notification message comprises receiving (FIG. 4, step 11) the notification message responsive to subscribing (FIG. 4, step 9) to the UMCF to get notifications.

6. The method of embodiment 5 wherein discovering (FIG. 4, steps 7-8) that the UMCF has restarted comprises:
sending (FIG. 4, step 7) a heartbeat request message to the UMCF; and
receiving (FIG. 4, step 8) a heartbeat response message comprising an incremented recovery time stamp.

7. The method of any of embodiments 1 to 6 wherein the core network entity is an AMF.

8. The method of any of embodiments 1 to 6 wherein the core network entity is an MME.

9. A method of operation a core network entity (e.g., UMCF) in a core network of a cellular communications system, the method comprising:
sending (FIG. 4, step 3; FIG. 4, step 11), to another core network entity (e.g., AMF or MME), a notification message that comprises a request to replace a PLMN UE radio capability ID(s) containing a first version ID with a PLMN UE radio capability ID(s) containing a second version ID, the second version ID being newer than the first version ID.

10. The method of embodiment 9 wherein the core network entity is a UMCF.

11. The method of embodiment 10 further comprising:
receiving (FIG. 4, step 1), from the other core network entity, a subscription message to get notifications;
wherein sending (FIG. 4, step 3; FIG. 4, step 11) the notification message comprises sending (FIG. 4, step 3) the notification message to the other core network entity responsive to receiving (FIG. 4, step 1) the subscription message.

12. The method of embodiment 10 wherein the UMCF is restarted, and the method further comprises, upon restarting:
receiving (FIG. 4, step 9), from the other core network entity, a subscription message to get notifications;
wherein sending (FIG. 4, step 3; FIG. 4, step 11) the notification message comprises sending (FIG. 4, step 11) the notification message to the other core network entity responsive to receiving (FIG. 4, step 9) the subscription message.

13. The method of embodiment 12 further comprising, upon restarting:
receiving (FIG. 4, step 7) a heartbeat request message from the other core network entity; and
sending (FIG. 4, step 8) a heartbeat response message to the other core network entity, the heartbeat response comprising an incremented recovery time stamp.

14. The method of any of embodiments 9 to 13 wherein the other core network entity is an AMF.

15. The method of any of embodiments 9 to 13 wherein the other core network entity is an MME.

16. A network node (500) for implementing a core network entity for a core network of a cellular communications system, the network node (500) adapted to perform the method of any one of embodiments 1 to 15.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Management Function
AN Access Network
AUSF Authentication Server Function
DN Data Network
DSP Digital Signal Processor
eNB Enhanced or Evolved Node B
EPC Evolved Packet Core
E-UTRA Evolved Universal Terrestrial Radio Access
gNB New Radio Base Station
HSS Home Subscriber Server
IP Internet Protocol
LTE Long Term Evolution
MME Mobility Management Entity
MTC Machine Type Communication
NEF Network Exposure Function
NF Network Function
NR New Radio
NRF Network Function Repository Function
NSSF Network Slice Selection Function
OTT Over-the-Top
PCF Policy Control Function
P-GW Packet Data Network Gateway
QoS Quality of Service
RAN Radio Access Network
SCEF Service Capability Exposure Function
SMF Session Management Function
UDM Unified Data Management
UE User Equipment
UPF User Plane Function

1. A method of operation a core network entity in a core network of a cellular communications system, the method comprising:
receiving, from another core network entity, a notification message that comprises a request to replace a PLMN UE radio capability ID(s) containing a first version ID with a PLMN UE radio capability ID(s) containing a second version ID, the second version ID being newer than the first version ID; and
performing one or more actions responsive to receiving the notification message.

2. The method of claim 1 wherein performing the one or more actions comprises sending, to a UE, a request to replace the PLMN UE radio capability ID(s) containing the first version ID with the PLMN UE radio capability ID(s) containing the second version ID.

3. The method of claim 1 wherein the other network entity is a UMCF.

4. The method of claim 3 further comprising:
subscribing to the UMCF to get notifications;
wherein receiving the notification message comprises receiving the notification message responsive to subscribing to the UMCF to get notifications.

5. The method of claim 3 further comprising:
discovering that the UMCF has restarted; and
responsive to discovering that the UMCF has restarted, subscribing to the UMCF to get notifications;
wherein receiving the notification message comprises receiving the notification message responsive to subscribing to the UMCF to get notifications.

6. The method of claim 5 wherein discovering that the UMCF has restarted comprises:
sending a heartbeat request message to the UMCF; and
receiving a heartbeat response message comprising an incremented recovery time stamp.

7. The method of claim 1 wherein the core network entity is an Access and Mobility Management Function, AMF, or a Mobility Management Entity, MME.

8. A method of operation a core network entity in a core network of a cellular communications system, the method comprising:
sending, to another core network entity, a notification message that comprises a request to replace a PLMN UE radio capability ID(s) containing a first version ID with a PLMN UE radio capability ID(s) containing a second version ID, the second version ID being newer than the first version ID.

9. The method of claim 8 wherein the core network entity is a UMCF.

10. The method of claim 9 further comprising:
receiving, from the other core network entity, a subscription message to get notifications;
wherein sending the notification message comprises sending the notification message to the other core network entity responsive to receiving the subscription message.

11. The method of claim 9 wherein the UMCF is restarted, and the method further comprises, upon restarting:
receiving, from the other core network entity, a subscription message to get notifications;
wherein sending the notification message comprises sending the notification message to the other core network entity responsive to receiving the subscription message.

12. The method of claim 11 further comprising, upon restarting:
receiving a heartbeat request message from the other core network entity; and
sending a heartbeat response message to the other core network entity, the heartbeat response comprising an incremented recovery time stamp.

13. The method of claim 8 wherein the other core network entity is an Access and Mobility Management Function, AMF, or a Mobility Management Entity, MME.

14. A network node for implementing a core network entity for a core network of a cellular communications system, the network node comprising processing circuitry configured to cause the network node to:
receive, from another core network entity, a notification message that comprises a request to replace a PLMN UE radio capability ID(s) containing a first version ID with a PLMN UE radio capability ID(s) containing a second version ID, the second version ID being newer than the first version ID; and
perform one or more actions responsive to receiving the notification message.

15. A network node for implementing a core network entity for a core network of a cellular communications system, the network node comprising processing circuitry configured to cause the network node to:
send, to another core network entity, a notification message that comprises a request to replace a PLMN UE radio capability ID(s) containing a first version ID with a PLMN UE radio capability ID(s) containing a second version ID, the second version ID being newer than the first version ID.
